(19) United States
(12) Patent Application Publication
(10) Pub. No.: US 2012/0023424 A1
(43) Pub. Date: Jan. 26, 2012

(54) Apparatuses and Methods for Generating Full Screen Effect by Widgets

(75) Inventors: Yuan-Chung Shen, Taipei City (TW); Cheng-Hung Ko, Taipei City (TW)

(73) Assignee: MEDIATEK INC., Hsin-Chu (TW)

(21) Appl. No.: 12/839,687

(22) Filed: Jul. 20, 2010

(51) Int. Cl. G06F 3/048

(52) U.S. Cl. 715/765; 715/764; 715/769

(57) ABSTRACT

An electronic interaction apparatus with a touch screen coupled thereto is provided. In the electronic interaction apparatus, a processing unit executes a widget, and the widget generates a widget image and at least one display object. Also, the widget displays the widget image in a frame on the touch screen, and displays the display object outside of the frame.

### BACKGROUND OF THE INVENTION

1. Field of the Invention

The invention generally relates to widgets, and more particularly, to apparatuses and methods for generating full screen effect by widgets.

2. Description of the Related Art

To an increasing extent, touch screens are being used for electronic devices, such as computers, mobile phones, media player devices, and gaming devices, etc., as human-machine interfaces. The touch screen may comprise a plurality of touch-sensitive sensors for detecting the contact of objects thereon; thereby, providing alternatives for user interaction therewith, for example, by using pointers, styluses, fingers, etc. Generally, the touch screen may be provided with a graphical user interface (GUI) for a user to view current statuses of particular applications or widgets, and the GUI is provided to dynamically display the interface in accordance with a selected widget or application. A widget provides a single interactive point for direct manipulation of a given kind of data. In other words, a widget is a basic visual building block associated with an application, which holds all the data processed by the application and provides available interactions on this data. Specifically, a widget may have its own functions, behaviors, and appearances.

Each widget that is built into electronic devices is usually used to implement distinct functions and further generate specific data in distinct visual presentations. The visual presentation of each widget may be displayed through a GUI provided by a touch screen. However, a user may only interact with a widget within a specific area of the visual presentation of the widget. Specifically, the touch events generated by a user may be used to interact with a widget, only if the touch events are detected within the specific area of the visual presentation of the widget. That is, the functional area of a widget is limited to a specific area of its visual presentation. Thus, the widget is limited in providing interactive flexibility.

### BRIEF SUMMARY OF THE INVENTION

Accordingly, embodiments of the invention provide apparatuses and methods for full screen widget effect. In one aspect of the invention, an electronic interaction apparatus is provided. The electronic interaction apparatus comprises a touch screen and a processing unit. The processing unit executes a widget, wherein the widget generates a widget image and at least one display object. Also, the widget displays the widget image in a frame, and displays the display object outside of the frame.

In another aspect of the invention, another electronic interaction apparatus is provided. The electronic interaction apparatus comprises a touch screen and a processing unit. The processing unit enables and executes a widget, wherein the widget updates a setting of a theme image on the touch screen and displays the theme image according to the updated setting. The theme image is not a widget image acting as a graphical user interface of the widget to interact with a user.

In an aspect of the invention, a full-screen effect generation method for an electronic interaction apparatus with a touch screen and a processing unit coupled thereto is provided. The full-screen effect generation method comprises the steps of executing, by the processing unit, a widget for generating a widget image and at least one display object, displaying, by the widget, the widget image in a frame, wherein the widget image acts as a graphical user interface to interact with a user, and displaying, by the widget, the display object outside of the frame.

In another aspect of the invention, another full-screen effect generation method for an electronic interaction apparatus with a touch screen and a processing unit coupled thereto is provided. The full-screen effect generation method comprises the steps of when a widget is enabled and executed by the processing unit, updating a setting of a theme image on the touch screen, and displaying the theme images according to the updated setting, wherein the theme image is not a widget image acting as a graphical user interface of the widget to interact with a user.

Other aspects and features of the present invention will become apparent to those with ordinarily skill in the art upon review of the following descriptions of specific embodiments of the apparatus and methods for full-screen effects.

### BRIEF DESCRIPTION OF DRAWINGS

The invention can be more fully understood by reading the subsequent detailed description and examples with references made to the accompanying drawings, wherein:

FIG. 1 is a block diagram of a mobile phone according to an embodiment of the invention;

FIG. 2 is a block diagram illustrating the software architecture of a widget system according to an embodiment of the invention;

FIGS. 3A and 3B are exemplary displays on the touch screen 16 according to an embodiment of the invention;

FIG. 4 is an exemplary display on the touch screen 16 according to another embodiment of the invention;

FIG. 5 is a flow chart illustrating a full-screen effect generation method according to an embodiment of the invention; and

FIG. 6 is a flow chart illustrating a full-screen effect generation method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

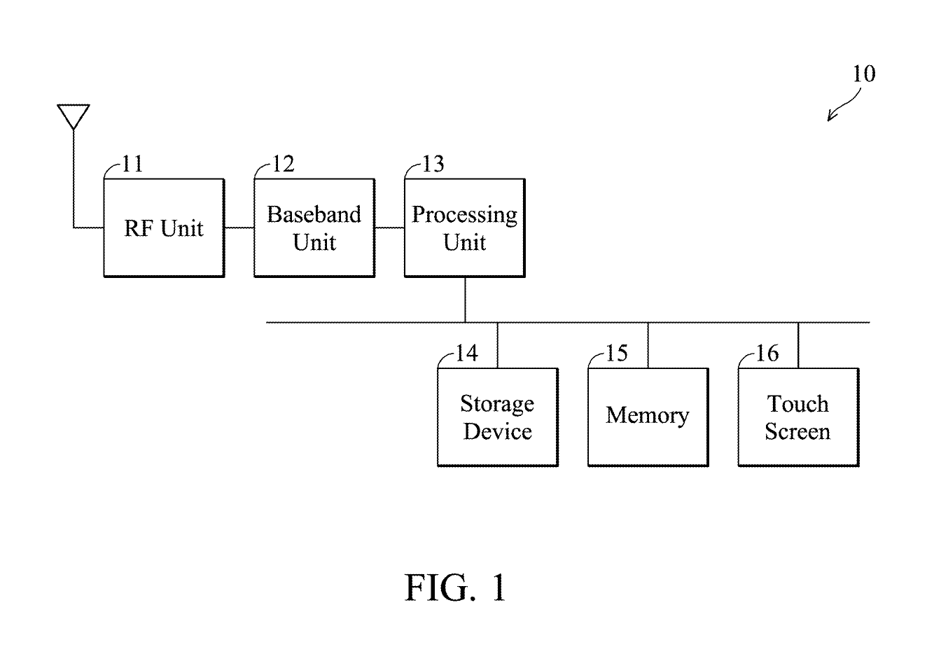

In order to provide a limitless way of widget interaction, the widgets described in this invention are capable of creating full-screen effects in addition to their own visual presentations. FIG. 1 is a block diagram of a mobile phone according to an embodiment of the invention. The mobile phone 10 is equipped with a Radio Frequency (RF) unit 11 and a Baseband unit 12 to communicate with a corresponding node via a cellular network. The Baseband unit 12 may contain multiple hardware devices to perform baseband signal processing, including analog to digital conversion (ADC)/digital to analog conversion (DAC), gain adjusting, modulation/demodulation, encoding/decoding, and so on. The RF unit 11 may receive RF wireless signals, convert the received RF wireless signals to baseband signals, which are processed by the Baseband unit 12, or receive baseband signals from the baseband unit 12 and convert the received baseband signals to RF wireless signals, which are later transmitted. The RF unit 11 may also contain multiple hardware devices to perform radio frequency conversion. For example, the RF unit 11 may comprise a mixer to multiply the baseband signals with a carrier oscillated in the radio frequency of the wireless communications system, wherein the radio frequency may be 900 MHz, 1800 MHz or 1900 MHz utilized in GSM systems, or may be 900 MHz, 1900 MHz or 2100 MHz utilized in WCDMA systems, or others depending on the radio access technology (RAT) in use. The mobile phone 10 is further equipped with a touch screen 16 as part of a man-machine interface (MMI). The MMI is the means by which people interact with the mobile phone 10. The MMI may contain screen menus, icons, text messages, and so on, as well as physical buttons, keypad and the touch screen 16, and so on. The touch screen 16 is a display screen that is sensitive to the touch or approximation of a finger or stylus. The touch screen 16 may be the resistive or capacitive type, or others. Users may manually touch, press, or click the touch screen to operate the mobile phone 10 with the indication of the displayed menus, icons or messages. A processing unit 13 of the mobile phone 10, such as a general-purposed processor or a micro-control unit (MCU), or others, loads and executes a series of program codes from a memory 15 or a storage device 14 to provide functionality of the MMI for users. It is to be understood that the introduced methods for full-screen widget effect may be applied to different electronic apparatuses, such as portable media players (PMP), global positioning system (GPS) navigation devices, portable gaming consoles, and so on, without departing from the spirit of the invention.

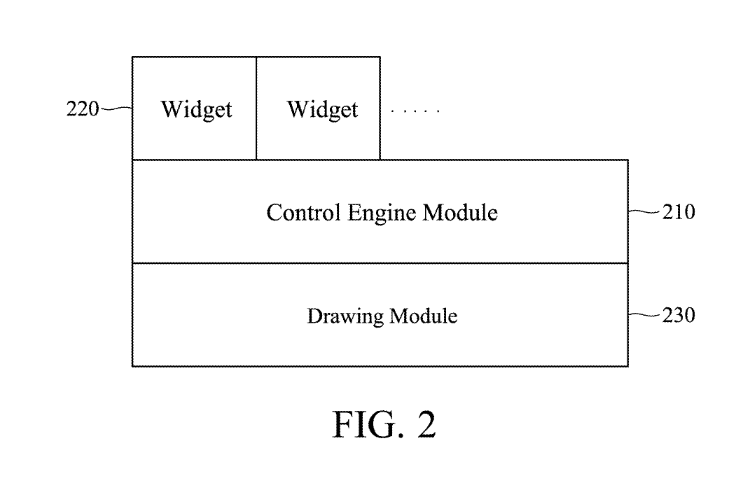

FIG. 2 is a block diagram illustrating the software architecture of a widget system according to an embodiment of the invention. The software architecture comprises a control engine module 210 providing a widget system framework for enabling a plurality of widgets, which is loaded and executed by the processing unit 13. Also, the control engine module 210 may request the drawing module 230 for drawing a full-screen image on the touch screen 16, such as a wallpaper, and controlling the updates of the full-screen image. The widget system framework functions as a hosting platform with necessary underlying functionalities for the operation of the widgets. Among the widgets, there is a widget 220, associated with a respective application, performing its own functions and having its own behaviors when being enabled (also, may be referred to as initialized) by the control engine module 210. Unlike conventional widgets, the widget 220 may provide full-screen effects outside of its own frame. Note that the widget may request the drawing module 230 to display a corresponding image in the frame, which acts as a graphical user interface (GUI) to interact with users. To be more specific, once being enabled and executed by the processing unit 13, the widget 220 may notify the drawing module 230 of replacing the currently used full-screen image with its own one, and/or drawing at least one display object in specific region on the replaced wallpaper, which is outside of its own frame. It is to be understood that, the wallpaper update may be alternatively triggered by the control engine module 210, instead of the widget 220. Before being disabled, the widget 220 may force the drawing module 230 to replace its full-screen image with the previous one, and remove all created display objects via the control engine module 210. The widget 220 may modify the operating statuses of the display object. The operating statuses may contain an appearance attribute, such as being present or hidden, a displayed coordinate on the touch screen 16, displayed length and width, or others. In one embodiment, the widget 220 may repeatedly start a timer to countdown from a specific value, and modify the operating statuses of the created widgets when the timer reaches zero. The periodicity of triggering times may be set to a constant value, such as representing 0.3, 0.5 or 1 second, or others. Or, the specific value for each restart may be a random value within a predetermined range, such as between 0.3 and 1 seconds, or others. The drawing module 230 may be designed to detect any change of the operating statuses of the display object, and update the corresponding images on the touch screen 16 whenever a change is detected. Alternatively, the drawing module 230 may be designed to periodically update all widget images in terms of their current operating statuses. In another embodiment, the widget 220 may alternatively generate the display objects each with a built-in timer. The display object may modify its own operating status when the timer reaches zero, thereby enabling the drawing module 230 to accordingly update the display object. Additionally, the display object may be designed to issue a trigger signal when the built-in timer expires, and the drawing module 230 may passively await the trigger signal for updating the corresponding image.

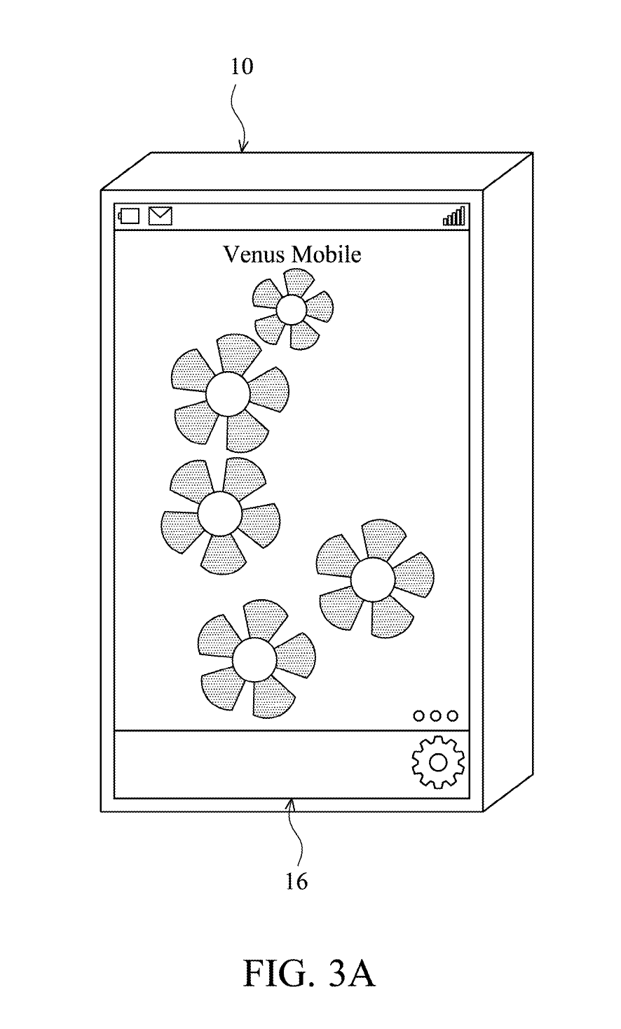

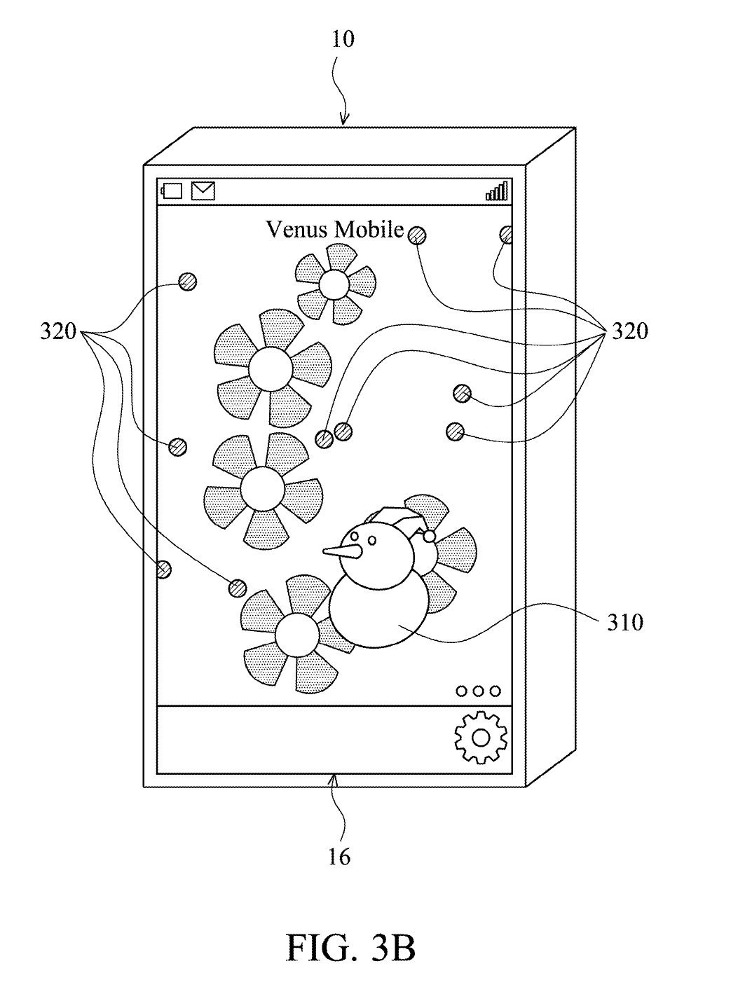

FIGS. 3A and 3B are exemplary displays on the touch screen 16 according to an embodiment of the invention. As shown in FIG. 3A, a full-screen image, such as a wallpaper, is displayed as the background on the touch screen 16, in which several flowers are scattered around. As the widget 220 is enabled by the control engine module 210, the widget 220 generates an image as its representative icon. Referring to FIG. 3B, the widget 220 may be enabled when the control engine module 210 detects that a corresponding icon has been dragged from a widget menu bar (as shown in the lower part of the touch screen 16) and dropped into a main area (as shown in the center area of the touch screen 16) by users. In this embodiment, the image 310 generated by the widget 220 is a snowman, as shown in FIG. 3B. While in other embodiments, the image 310 generated by the widget 220 may be a virtual clock, a virtual calendar, or an iconic character, such as the SpongeBob, WALL-E, and Elmo, etc. In addition to the image 310 of a snowman, the widget 220 also generates a plurality of display objects 320, such as respective snowflake images, to be displayed in the full-screen image. Specifically, the drawing module 230 may perform a blending procedure to merge the display objects, i.e. the snowflake image, into the full-screen image. The widget 220 further periodically updates the operating statuses of the display object 320, such as information concerning the position, the transparency, and the opacity. Accordingly, the drawing module 230 performs the blending procedure again, to update the full-screen image with the display object having the modified operating statuses. It is noted that the full-screen image and the widget image 310 are displayed on the touch screen 16 in layers, in which the widget image 310 is on top of the full-screen image.

In one embodiment, the widget 220 may start a plurality of timers respectively corresponding to the plurality of snowflakes, i.e. the display object 320. As each of the timers expires, the widget 220 updates the position of the corresponding snowflake in a way that the corresponding snowflake appears to fall down gently, and then restarts the timer. Thus, a full-screen effect is provided with falling snowflakes in the full-screen image. Additionally, the widget 220 may further increase the transparency or decrease the opacity of a snowflake every time the corresponding timer expires, so that the snowflake appears to be melted away as it falls down. In another embodiment, the display objects 320, instead of the widget 220, may be designed to perform the timer controls and the updates of the snowflakes as described above. Moreover, the widget 220 may remove the display objects 320 as the snowflakes are fallen outside of the touch screen 16, or alternatively, reset the positions of the fallen-out snowflakes to the top of the touch screen 16. Pseudo code for the position updates of the snowflakes is addressed below as an example:

```
function changeSnowflakePosition
{
  for each snowflake
  {
    get snowflake position (x, y);
    x + a random number between −5 ~ 5;
    y + a random number between 1~3;
    change snowflake position;
    if (snowflake is at the bottom of the screen)
    {
      re-position the snowflake from the top of the screen;
    }
  }
  start timer to next changeSnowflakePosition;
}
```

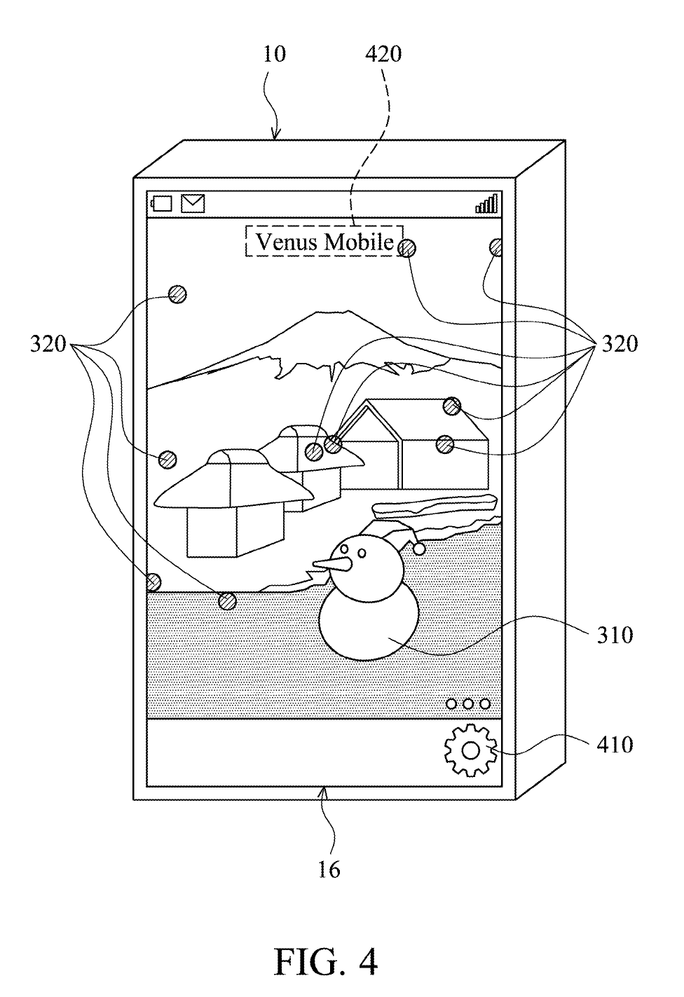

Another embodiment is described below. In this embodiment, before the widget 220 is enabled, the touch screen 16 displays a plurality of theme images generated by the drawing module 230, including a wallpaper image, a set of system icon images, and/or prompts, as shown in FIG. 3A. Note that the theme image is not an image acting as a GUI of the widget, such as 310 of FIG. 3B, to interact with a user. As shown in FIG. 4, when being enabled by the control engine module 210, the widget 220 first generates a snowman image 310, and then sends a trigger signal to request the control engine module 210 for placing the snowman image 310 on a specific position of the touch screen 16. Then, the drawing module 230 updates the theme images according to information indicated by the control engine module 210. The updating of the theme images includes replacing the currently used wallpaper image with a winter-themed one, modifying the font type of the telecom operator prompt “Venus Mobile” from the Times New Roman style to the Arial style in Bold, and/or modifying the color of the system icon image 410 from gray to white. It is to be understood that it is not limited to the wallpaper image, the system icon images, and the font images, and similar but different updates may be contemplated from the example described above. Specifically, a special animation may be played for the updating of the theme images. For example, the winter-themed wallpaper image may be gradually pasted on top of the original one from the upper left corner to the lower right corner of the touch screen 16 in a visually perceivable animation. The original set of icon images may be moved out of the touch screen 16 and a new set of icon images may be moved into the touch screen 16 in a visually perceivable animation. For example, the original set of icon image 410 flies rightward and out of the touch screen 16 in response to the enabling of the widget 220, and then a new set of icon images flies in from the left-hand side of the touch screen 16. The original settings of the font style, font size, and font color to the prompt 420 may be changed to another character by character. Later on, when the widget 220 is terminated, the previously replaced settings, including the wallpaper image, settings to the system icon image 410, and the font style of the telecom operator prompt 420, or others, may be restored. Details of the mentioned special effects may be controlled by the control engine module 210. The widget may be terminated when the control engine module 210 detects that the image 310 has been dragged from a main area (as shown in the center area of FIG. 4) and dropped into a widget menu bar (as shown in the lower area of FIG. 4) by users. In short, these setting are functionally correlated with the widget 220. Once the widget 220 is enabled or disabled, the settings have to be updated accordingly. Another example of the widget 220 may create a look-and-feel of HelloKitty™, including pink-style settings to the wallpaper image, prompts, icon image, or others, and the invention is not limited thereto.

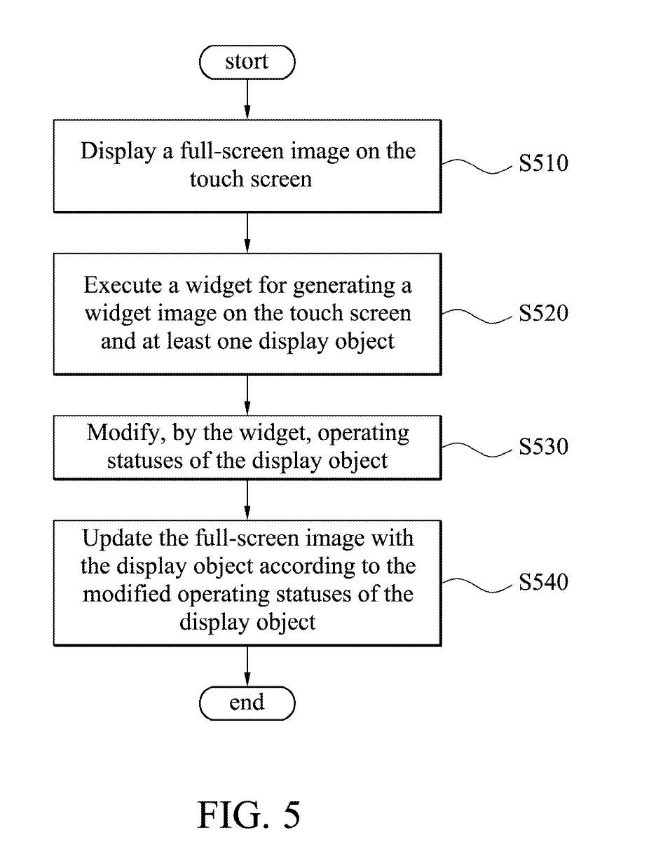

FIG. 5 is a flow chart illustrating a full-screen effect generation method according to an embodiment of the invention. The method may be applied for any widget in an electronic interaction apparatus with a touch screen. Take the widget 220 in FIG. 3B for example. When the mobile phone 10 is started up, a series of initialization processes, including booting up of the operating system, initializing of the control engine module 210, and activating of the embedded or coupled functional modules (such as the touch screen 16), etc., are performed. After the initialization processes are finished, the processing unit 13 first executes the drawing module 230 for displaying a full-screen image on the touch screen 16 (step S510), such as the full-screen image in FIG. 3A. Subsequently, the processing unit 13 executes the widget 220 for generating a widget image and at least one display object (step S520). The widget 220 may be created and initialized via the control engine module 210 in response to user operations, and further enabled by the control engine module 210. When being enabled by the control engine module 210, the widget 220 generates the widget image and the display object. Also, the widget 220 modifies the operating statuses of the display object (step S530). Accordingly, the drawing module 230 updates the full-screen image with the display object according to the modified operating statuses thereof (step S540). Specifically, the drawing module 230 performs a blending procedure to merge the display objects, i.e. the snowflake image, into the full-screen image. To further clarify, the display object is allowed to be displayed on the outside of a given frame of the widget 220. The steps S530 and S540 may be designed as recurring steps for periodically updating the full-screen image with the latest updated display object. Regarding the exemplary implementations of the periodical update of the display object, reference may be made to the detailed descriptions in relation to FIGS. 3A and 3B.

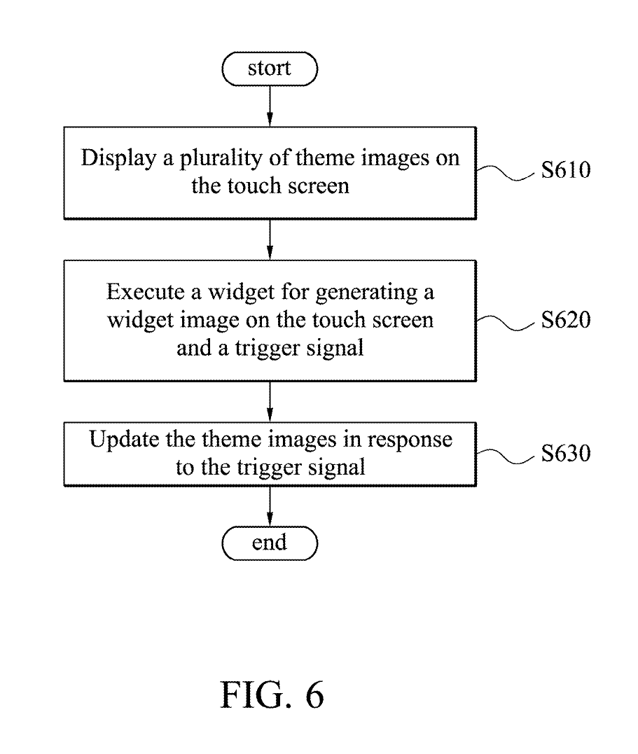

FIG. 6 is a flow chart illustrating a full-screen effect generation method according to another embodiment of the invention. Take the mobile phone 10 in FIG. 4 for example. When the mobile phone 10 is started up, a series of initialization processes, including booting up of the operating system, initializing of the control engine module 210, and activating of the embedded or coupled functional modules (such as the touch screen 16), etc., are performed. After the initialization processes are finished, the processing unit 13 first executes the drawing module 230 for displaying a plurality of theme images (step S610), such as the wallpaper image, the system icon image 410, and the prompt 420, as shown in FIG. 4. Subsequently, the processing unit 13 executes the widget 220 for generating a widget image on the touch screen 16 and a trigger signal (step S620). The widget may be created via the control engine module 210 in response to user operations, and further enabled by the control engine module 210. When being enabled by the control engine module 210, the widget 220 generates the widget image, such as the snowman 310 in FIG. 4, and also generates a trigger signal to the drawing module 230. In response to the trigger signal, the drawing module 230 updates the theme images accordingly (step S630). For example, as shown in FIG. 4, the wallpaper image is replaced with a winter-themed one, the font type of the telecom operator prompt “Venus Mobile” is changed from a Times New Roman style to an Arial style in Bold, and the color of the system icon image 410 is changed from gray to white. In addition, a special animation may be played for the updating of the theme images. For example, the winter-themed wallpaper image may be gradually pasted on top of the original one from the upper left corner to the lower right corner of the display screen in a visually perceivable animation, the original set of icon images may be moved out of the display area and a new set of icon images may be moved into in a visually perceivable animation, or the original settings of the font style, font size, and font color to the prompt 420 may be changed to another character by character. Details of the mentioned special effects may be controlled by the control engine module 210.

It is noted that the widget image, and the display objects or theme images, are functionally correlated. To further clarify, once the widget 220 is enabled, the display objects are added to the wallpaper image, or the theme images are updated accordingly. Afterwards, when the widget 220 is terminated, the display objects 320 in FIG. 3B are removed from the wallpaper or the theme images in FIG. 4 may be restored to their original settings. In addition, the widget 220 may be created and initialized when the control engine module 220 detects that a corresponding widget icon is dragged from a widget menu (such as the lower bar shown in FIG. 3A) and dropped into the main display area (such as the major part on the touch screen where the pedals are scattered around in FIG. 3A) by an user. The widget 220 may further be terminated when the widget image is dragged from the main display area and dropped back to the widget menu.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic interaction apparatus, comprising:
a touch screen;
a processing unit executing a widget,
wherein the widget generates a widget image and at least one display object, displays the widget image in a frame on the touch screen, and displays the display object outside of the frame.

2. The electronic interaction apparatus of claim 1, wherein the widget further starts a timer, modifies of an operating status of the display object, and displays the display object according to the modified operating status when the timer expires.

3. The electronic interaction apparatus of claim 1, wherein the operating status of the display object comprises information concerning a position, and a transparency or an opacity of the display object.

4. The electronic interaction apparatus of claim 3, wherein the widget further removes the display object when the updated position of the display object is outside of a display area on the touch screen.

5. The electronic interaction apparatus of claim 3, wherein the widget further adjusts the updated position of the display object to be within the touch screen when the updated position of the display object is out of a display area on the touch screen.

6. The electronic interaction apparatus of claim 1, wherein the image acts as a graphical user interface to interact with a user.

7. An electronic interaction apparatus, comprising:
a touch screen;
a processing unit,
wherein a widget, when enabled and executed by the processing unit, updates a setting of a theme image on the touch screen and displays the theme image according to the updated setting, and the theme image is not a widget image acting as a graphical user interface of the widget to interact with a user.

8. The electronic interaction apparatus of claim 7, wherein the theme image comprises a wallpaper image, and the widget, when enabled and executed by the processing unit, replaces currently used wallpaper image with a new wallpaper image.

9. The electronic interaction apparatus of claim 8, wherein the widget plays an animation to paste the new wallpaper image on top of the currently used wallpaper image from one corner to another.

10. The electronic interaction apparatus of claim 7, wherein the theme image comprises an icon image, and the widget, when enabled and executed by the processing unit, plays an animation to move currently used icon image out of the touch screen and to fly in a new icon image.

11. The electronic interaction apparatus of claim 7, wherein the theme image comprises a prompt, and the widget, when enabled and executed by the processing unit, plays an animation to update currently used font style, font size or font color of the prompt with a new font style, font size, or font color thereof.

12. The electronic interaction apparatus of claim 7, wherein the setting of the theme image is restored when the widget is terminated.

13. A full-screen effect generation method for an electronic interaction apparatus with a touch screen and a processing unit coupled thereto, comprising:
executing, by the processing unit, a widget for generating a widget image and at least one display object;
displaying, by the widget, the widget image in a frame on the touch screen, wherein the widget image acts as a graphical user interface to interact with a user; and
displaying, by the widget, the display object outside of the frame.

14. The full-screen effect generation method of claim 13, wherein the widget is executed when a widget icon is detected to be dragged from a widget menu bar on the touch screen and dropped into a main area on the touch screen.

15. The full-screen effect generation method of claim 13, further comprising:
starting a timer;
updating, by the widget, a position of the display object when the timer expires; and
displaying the display object on the updated position of the touch screen.

16. The full-screen effect generation method of claim 13, further comprising removing the display object from the touch screen when the widget is terminated.

17. The full-screen effect generation method of claim 16, wherein the widget is terminated when the widget image is detected to be dragged from a main area on the touch screen and dropped into a widget menu bar on the touch screen.

18. A full-screen effect generation method for an electronic interaction apparatus with a touch screen and a processing unit coupled thereto, comprising:
when a widget is enabled and executed by the processing unit, updating a setting of a theme image on the touch screen; and
displaying the theme images according to the updated setting, wherein the theme image is not a widget image acting as a graphical user interface of the widget to interact with a user.

19. The full-screen effect generation method of claim 18, wherein the widget is enabled and executed when a widget icon is detected to be dragged from a widget menu bar on the touch screen and dropped into a main area on the touch screen.

20. The full-screen effect generation method of claim 18, further comprising restoring the setting of the theme image when the widget is terminated.

21. The full-screen effect generation method of claim 20, wherein the widget is terminated when widget image is detected to be dragged from a main area on the touch screen and dropped into a widget menu bar on the touch screen.
